(19) United States
(12) Patent Application Publication
(10) Pub. No.: US 2016/0162949 A1
(43) Pub. Date: Jun. 9, 2016

(54) METHOD AND APPARATUS FOR PRESENTING A SOFTWARE ADVERTISING OFFER

(71) Applicant: Red Online Marketing Group, LP, Philadelphia, PA (US)

(72) Inventors: Gabriel Malca, Cote-Saint-Luc (CA); Craig Slusher, Havertown, PA (US)

(73) Assignee: Red Online Marketing Group, LP, Philadelphia, PA (US)

(21) Appl. No.: 14/869,589

(22) Filed: Sep. 29, 2015

Related U.S. Application Data
(60) Provisional application No. 62/057,044, filed on Sep. 29, 2014.

(51) Int. Cl. G06Q 30/02

(52) U.S. Cl. CPC G06Q 30/0262

(57) ABSTRACT

Methods and apparatuses are described herein for presenting an advertising offer to a user. The presentation of an advertising offer is made via a software application running on the computer or client device of the user. The software application may detect a triggering event, such as a file execution, on the computer or client device of the user. The software application may then suspend execution of an application associated with the triggering event and may then send a request to a server that includes data associated with the user or the suspended/intercepted application. The software application may then receive a response from the server including a determination of whether the advertising offer should be presented to the user, and according to such response may activate a display to display the advertising offer via the user computer or client device. Finally, the software application may then resume the suspended/intercepted application.

### CROSS REFERENCE TO RELATED APPLICATIONS

This application claims the benefit of U.S. Provisional Application No. 62/057,044 filed Sep. 29, 2014, the content of which is hereby incorporated by reference.

### FIELD OF THE INVENTION

The present application is generally related to internet advertising technology and more particularly related to a method and apparatus for presenting an advertising offer to software users.

### BACKGROUND

Advertising technology has developed and changed significantly in the internet age, as the world wide web presents vast opportunities for advertisers, publishers, and networks. Advertisers are constantly seeking to differentiate themselves and, in the process, find new and creative placements to present advertising offers to consumers. Conversely, software creators and distributors are also seeking ways to monetize their assets, often through advertising associated with their software. Furthermore, those software creators and distributors are often seeking advertising opportunities themselves to further market and disseminate their software products. In particular, creators, owners, and distributors of desktop, mobile, tablet, and other software products seek to identify the best opportunities to present potential users with offers to download and install their software products, while reducing the number of steps and complexity to convert a user from viewing an advertisement or offer to installing the software product.

Currently, various technologies and techniques exist in the internet advertising and marketing industry to connect advertisers with end users. The entity that provides or is represented in the advertising content is often referred to as the “advertiser,” while the entity that delivers such advertising content to the end user or consumer is often referred to as the “publisher.” In one example, the publisher may be an online website owner or operator, who incorporates advertising content into the website content in order to monetize the website. Alternatively, the publisher may be a software company that offers free downloadable software products, which are “ad-supported,” meaning that in exchange for downloading and using the software free of charge, the user agrees to be shown advertisements while they browse the internet. Additionally, as discussed below, the software product company that acts as a publisher may promote other software companies' products by “bundling” or including those third party software products with downloads or installations of the publisher's own software products, such as in the form of additional recommended software or add-on software presented to the user. As discussed above, software companies often fall into both categories of advertiser and publisher. In order to promote their products and increase its number of users, software companies may advertise their products by partnering with search engine publishers, so that links to their software products appear as one of the top search results when potential customers search for certain keywords using the search engine. Software companies may also advertise their products on websites likely to have users interested in their products, such as technology websites. Furthermore, software companies may partner with other software publishers by “bundling” their software products with the publisher's own software, so that when users download, install, or execute the publisher's software the advertiser's software is offered to the user during the download, installation, or execution process. Such bundling relationships can also be established using websites known as “download portals,” which have large libraries of software offered to users for free, and provides users with offers to download and install other software while visiting the website or during the installation process of the free software.

While existing business models, including those described above, provide advertisers such as software companies with a number of options for marketing their products to end users, they focus mainly on providing advertising revenue to website publishers and not necessarily software makers. The practice of co-bundling software products allows software advertisers and publishers to both benefit from the relationship, but such arrangements in limited in terms of reach and number of end users. Furthermore, as internet users become more familiar with existing modes of online advertising, the effectiveness of certain types of advertising decreases. Accordingly, a need exists for technology that allows software advertisers and publishers to promote and monetize their assets, present advertising or software offers to end users or consumers in new ways, and increase the pool of potential users or consumers. A need further exists for expanding internet advertising beyond current opportunities, and taking advantage of user interactions with software beyond download portal websites and software co-bundling practices.

### SUMMARY

Methods and apparatuses are described herein for presenting an advertising offer to a user, such as a software installation offer. The presentation of an advertising offer, such as a software installation offer, is made via a software application running on the computer or client device of the user. The software application may detect a file execution on a device of the user, which may include a personal computer, smartphone, tablet computer, or other smart device such as wearable smart devices in the form of smart-watches, smart-bands, or smart-glasses. The software application may then suspend execution of a setup or uninstaller application, on a condition that the file execution is associated with the setup or uninstaller application. The software application may then send a request to a server that includes data associated with the user. The user data may include information including but not limited to the location of the user and other software applications installed on the device of the user. The software application may then receive a response from the server that includes at least one advertising offer, such as a software installation offer. The software application may then activate a display to display the at least one advertising offer, such as a software installation offer, based on the response from the server. Finally, the software application may then resume the setup or uninstaller application.

### BRIEF DESCRIPTION OF THE DRAWINGS

A more detailed understanding may be had from the following description, given by way of example in conjunction with the accompanying drawings wherein:

FIG. 1 is a system diagram of the high level architecture of an exemplary system implementing the Interceptor;

FIG. 2A is an example flow diagram of the process that may be performed by the Interceptor in accordance with one embodiment; and

FIG. 2B is a continuation of the example flow diagram of the process that may be performed by the Interceptor in accordance with one embodiment; and

FIG. 3 is an example flow diagram of the server side process that may be performed based on requests from the Interceptor in accordance with on embodiment.

### DETAILED DESCRIPTION

Methods, systems, and apparatuses are described herein for presenting an advertising offer to a user, such as for example an offer for downloading and installing a suggested software program. The presentation of a software installation offer is made via a software component (hereinafter the “Interceptor”) running on the client device of the user. The name “Interceptor” is used herein for ease of reference, and should not be interpreted as limiting the present application in any way, such as requiring the present software component to intercept or interrupt any process or application on the user's client device. One of ordinary skill in the art would appreciate that the Interceptor can be an individual component of a larger software program, part of one or more different software components, or its own standalone software program. Furthermore, the Interceptor can be part of or constitute an application, feature, device, system, network, or mechanism that operates in the manner described herein.

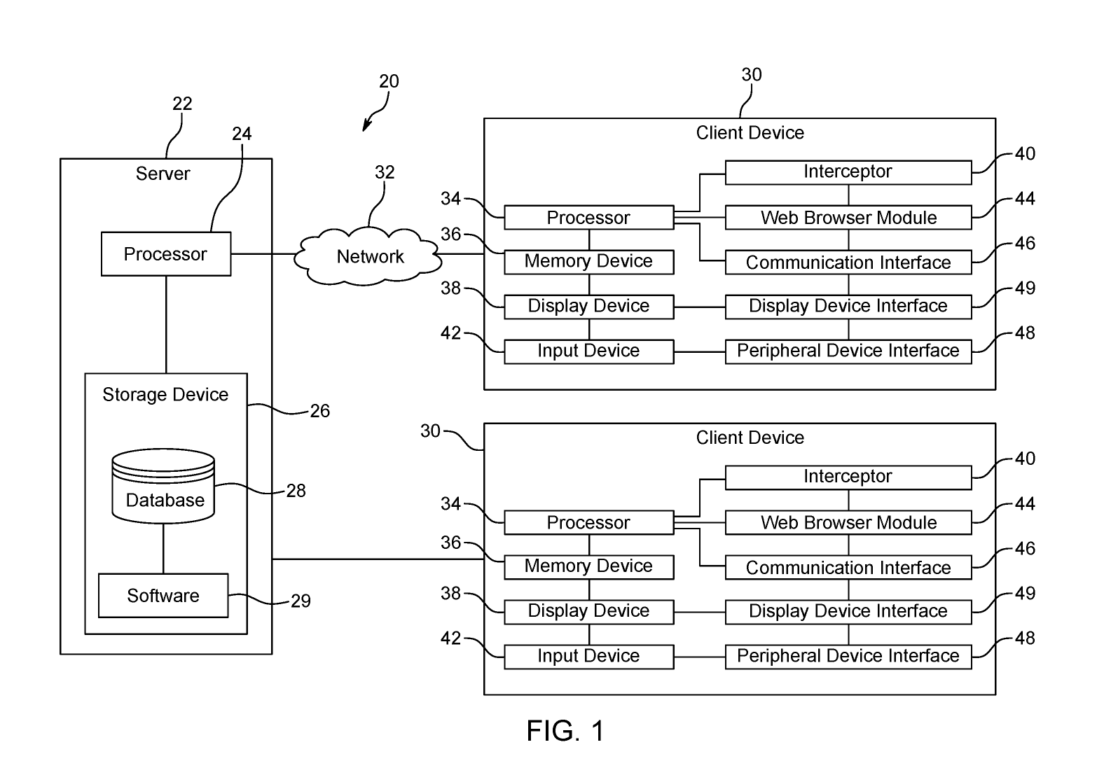

FIG. 1 illustrates an embodiment of a simplified system 20 that implements the Interceptor according to the present application to present advertising offers to a user. The system 20 includes a server 22, which may further include a processor 24, a storage device 26, a database 28, and software 29. The server 22 may also be associated with, or incorporated into, any suitable type of computing device, such as, for example and without limitation, a personal computer, a programmable logic controller, or a mobile computing device. The server 22 is in communication with one or more client devices 30, which may be directly associated with the server 22, such as through a direct connection (either wired or wireless) or by being part of the same machine. Alternatively, the client device 30 may communicate with the server 22 through a network 32 via either a wired or wireless connection, as described in further detail below. The client devices 30 shown in FIG. 1 may be, for example and without limitation, a desktop computer, a laptop computer, a netbook, a tablet computer, any suitable type of computing device, a personal digital assistant (PDA), a cellular phone such as a smartphone, a smart device such as a wearable smart device in the form of a smart-watch, smart-band, or smart-glasses, or any other appropriate device. The client device 30 may each include a processor 34, a memory device 36, a display device 38, an input device 42, and a web browser module 44, which may be in communication with one another and with any other associated components of the client device 30 using any suitable type of communication device, such as a data bus. The client device 30 may further include the Interceptor 40, which as described above, may be one component of a larger software application on the client device 30. Additionally, the Interceptor 40 may reside entirely on the client device 30, or may alternatively include certain sub-components that reside on the server 22, for example as part of the software 29 on the server 22. Using the client device 30, a user may interact with the Interceptor 40 in accordance with any of the embodiments described herein. The client device may further include a communication interface 46, peripheral device interface 48, display device interface 49, which may be coupled to or included within the other components described above, such as the display device 38 and the input device 42.

The memory device 36 in the client device 30 may be or include a device such as a Dynamic Random Access Memory (D-RAM), Static RAM (S-RAM), other RAM, a flash memory, or any other suitable computer-readable medium. The memory device 36 may also be part of or in communication with a storage device of another component in the system 20, such as the storage device 26 of the server 22. The storage device 26 may be or include a hard disk, a solid-state drive (SSD), a magneto-optical medium, an optical medium such as a compact disc-read only memory (CD-ROM), a digital versatile disk (DVD), a Blue-Ray disk (BD), or any other type of computer-readable medium or suitable device for electronic data storage.

The communication interface 46 in the client device 30 may be, for example and without limitation, a communications port, a wired transceiver, a wireless transceiver, or a network card. The communication interface 46 may be capable of communicating using technologies such as Ethernet, fiber optics, microwave, satellite, Public Switched Telephone Network (PTSN), DSL (Digital Subscriber Line), Broadband over Power Lines (BPL), WLAN technology, wireless cellular technology, or any other appropriate technologies.

The peripheral device interface 48 in the client device 30 may be configured to communicate with one or more peripheral devices, such as the user input device 42. The peripheral device interface 48 may operate using technologies such as, for example and without limitation, Universal Serial Bus (USB), PS/2, Bluetooth, infrared, serial port, parallel port, or any other appropriate technologies. The peripheral device interface 48 may receive input data from an input device 42 such as a keyboard, mouse, trackball, pointing stick, touch screen, touch pad, stylus pad, or other suitable devices.

The display device interface 49 in the client device 30 may be configured to communicate data to the display device 38. The display device 38 may be, for example and without limitation, a monitor or television display, a plasma display, a liquid crystal display (LCD), or a display based on a technology such as front or rear projection, light emitting diodes (LEDs), organic light-emitting diodes (OLEDS), or Digital Light Processing (DLP). The display device interface 49 may operate using technology such as Video Graphics Array (VGA), Super VGA (S-VGA), Digital Visual Interface (DVI), High-Definition Multimedia Interface (HDMI), or any other appropriate technologies. The display device interface 49 may communicate display data from the processor 34 to the display device 38 to be displayed by the display device 38. The display device 38 may be external to the rest of the client device 30 and coupled to the client device 30 via the display device interface 49. Alternatively, the display device 49 may be included in the client device 30 and may be part of the same component as the input device 42, such as a touch screen display.

The web browser module 44 shown in FIG. 1 may include and/or communicate with one or more sub-modules that perform functionality such as rendering HTML (including HTML5), rendering raster and/or vector graphics, executing JavaScript, and/or rendering multimedia content. The web browser module 44 or its sub-modules may also implement technologies such as Rich Internet Application (RIA), Adobe Flash, Microsoft Silverlight, or any other appropriate multimedia technologies. These multimedia technologies may be implemented using one or more web browser plug-in modules and/or by using one or more sub-modules within the web browser module 44 itself.

As discussed above, the storage device 26 of the server 22 shown in FIG. 1 may include a database 28, which may be spread across one or more non-transitory computer-readable storage mediums, and may be or include one or more relational databases, hierarchical databases, object-oriented databases, one or more flat files, one or more spreadsheets, and/or one or more structured files. The non-transitory computer-readable storage medium may store instructions to execute any of the methods described herein. The database 28 may be managed by one or more database management systems, which may be based on a technology such as, for example and without limitation, Microsoft SQL Server, MySQL, PostgreSQL, Oracle Relational Database Management System (RDBMS), a NoSQL database technology, or any other appropriate technologies. The database may include a number of different types of data that are used by the server 22, which may be in communication with the Interceptor 40 over a network 32 including but not limited to the Internet, a wireless local area network (WLAN), and/or a cellular network. The database 28 may further be in communication with a software 29 of the server 22, which may operate in conjunction with the Interceptor 40, or make up a component of the Interceptor 40.

An instance of the computing devices, including the exemplary client devices 30 and server 22 shown in FIG. 1, may be configured to perform any feature or any combination of features and methods described herein. Alternatively or additionally, the memory device 36 and/or the storage device 26 of the client device 30 and server 22 may store instructions which, when executed by the processor 24, 34, cause the processor 24, 34 to perform any feature or any combination of features and methods described herein. Furthermore, each or any of the features and methods described herein may be performed by the processor 24, 34 in conjunction with the memory device 36, web browser module 44, communication interface 46, peripheral device interface 48, display device interface 49, and/or storage device 26. Specifically, the client device 30 may be used to run the Interceptor 40, and the server 22 may be in communication with the Interceptor 40 over the network 32.

As used herein, the term “processor” in reference to the processors 24, 34 of the server 22 and client device 30 broadly refers to any unit, module, or machine capable of executing a sequence of instructions, such as, for example and without limitation, a single-core or multi-core processor, a general purpose processor, a special purpose processor, a conventional processor, a Graphics Processing Unit (GPU), a digital signal processor (DSP), one or a plurality of microprocessors, one or more microprocessors associated with a DSP core, a controller, a microcontroller, one or more Application Specific Integrated Circuits (ASICs), one or more Field Programmable Gate Array (FPGA) circuits, any other type of integrated circuit (ID), a system-on-a-chip (SOC), a Complex Instruction Set Computer (CISC), a Reduced Instruction Set Computer (RISC), or a state machine.

As used herein, the term “non-transitory computer-readable medium” broadly refers to any storage medium that may store or transfer information, including volatile, nonvolatile, removable, and non-removable media. Examples of a computer-readable medium include, but are not limited to, a register, a cache memory, an electronic circuit, a fiber optic medium, a Read Only Memory (ROM), a semiconductor memory device (such as a D-RAM, S-RAM, or other RAM), a magnetic medium (such as a hard disk drive, a tape drive, a magneto-optical medium, or a floppy drive), a flash memory medium (such as a USB flash drive or a flash memory card), a flash based or D-RAM based solid-state drive (SSD), an optical disk (such as CDs, DVDs, or BDs), or any other suitable device for electronic data storage.

Although the methods and features of the present application were described herein as performed using the example architecture of FIG. 1 the present method and features may be performed, mutatis mutandis, using any appropriate architecture or environment. For example and without limitation, the Interceptor 40 features described herein may be implemented using cloud computing technologies. Additionally, the components of the server 22 may be included as part of, or the same components as, those of the client device 30, such that the steps and operations described below as being performed by the server 22 are performed locally on the client device 30 instead. Furthermore, although the web browser module 44 in the client device 30 is described herein as implementing specific web browser technologies, it should be understood that the features described herein as performed by the web browser module 44 may alternatively or additionally be implemented using a specific purpose application, including but not limited to an application that is configured to run on an operating system such as Microsoft Windows, Apple OS X, Unix, Linux, Android, Windows Mobile, Apple iOS, or any other appropriate general purpose or mobile operating system.

The present Interceptor 40 allows offers (including advertising offers such as suggested software installations) to be shown to a user even when the user is not browsing the web and without requiring the user to download and install co-bundled software applications from the internet. Instead, the Interceptor 40 takes advantage of software that is already present on a user's computer as well as various software applications that a user obtains and installs on a periodic basis, including without limitation automatic or manual software updates, which do not necessarily have any advertising components or relationship with other software partners. As discussed above, the Interceptor 40 may be a separate standalone application installed on the user's computing device or other client device 30. The Interceptor 40 may be a component of a larger software application that provides the user with some value, feature, or service, which the user would download and install. For purposes of this application and ease of reference, a software application that includes the Interceptor 40 will be referred to as the “container software,” which term is used for convenience only and is not limiting. The container software can be provided by the same software company or distributor as the Interceptor 40, and can be a free software that generates revenue for the software owner or distributor through the advertising offers presented to the user of the container software by the Interceptor 40 component. Alternatively, the Interceptor 40 may be included in and distributed with a different company or distributor's own software application, as a way to monetize that company or distributor's software application. The container software can be any software program that users would install on their client devices, as the Interceptor 40 component of the container software does not interfere with the container software's normal operation or routines. For example and without limitation, the container software may be an antivirus application, a video or music player application, a content downloading application, a game application, a computer cleaner application, a file formatting application, or a mobile application. The container software may also be a software monitoring application that notifies the user when certain software on the user's computer is out of date or when new software updates are available.

As discussed above, the Interceptor 40 allows advertising offers and other content to be presented to a user who has installed the Interceptor 40 on a client device, whether as a standalone application or as part of a container software. In this manner, the owner of the Interceptor 40 component can generate advertising revenue from advertisers who pay a fee to have their advertising offers, software installation offers, or other content displayed to the end user. In addition, where the owner of the Interceptor 40 component and the owner of the container software are separate entities, both parties can generate advertising revenue by sharing in the fees paid by the advertisers whose advertising offers are displayed to the end use of the container software. For example and without limitation, advertisers may be charged a fee based on the display of an advertisement to the end user, based on an action taken by the end user such as a click, download, or installation of the advertising material, or software offer, or based on a percentage of the revenue earned by the advertiser as a result of the user interacting with the advertising material, such as when the user purchases the advertised product or service. One of ordinary skill in the art would understand that the Interceptor 40 can be utilized to present any type of advertising offer or content to the end user, including non-revenue generating informational content, as long as the advertising offer or content can be displayed, presented, downloaded, or installed on the user's client device 30. For example and without limitation, the advertising offer may be a display advertisement, a video advertisement, an audio advertisement, a promotion, a survey, a short puzzle or game, an offer for a software installation, an offer for a free service or product, an informational offer, or any combination of the foregoing. Accordingly, although the Interceptor 40 is described below as displaying an advertising offer in the form of a suggested software installation, one of ordinary skill in the art would appreciate that the present Interceptor 40 is not limited to software installation offers, but rather can present any type of advertising or other content to the end user.

After installation of the Interceptor 40 on a client device 30 of the user as defined above, either via a container software or as a standalone application, the Interceptor 40 may retrieve one or more advertising offers or content, such as software installation files, from the server or another source that may be later displayed or launched when the user views or accepts an advertising offer presented by the Interceptor 40. The Interceptor 40 may also periodically send a request to the server 22 or another source (such as an advertising partner) to receive an updated one or more advertising offers, such as software installer files, to store on the computer of the user. For example and without limitation, the retrieved one or more advertising offers may be saved with the temporary files on a user's computer, or may be saved in a different location such as the directory file for the Interceptor 40 or the container software. Alternatively, the Interceptor 40 may not retrieve or attempt to retrieve the one or more advertising offers until it is triggered to do so, such as when it detects that a triggering event such as when a file has been executed on the client device, and there is an opportunity to present the advertising offer to the user. Where the advertising offers presented to the end user are suggested software installations, the owner of Interceptor 40 and/or the container software may have a business relationship with the owners of the suggested software applications, which will be referred to as the “advertised software” for sake of clarity. Once again, the use of the term “advertised software” is for convenience early and is not limiting. In this scenario, the owner of the advertised software can be thought of as the “advertiser” in the business relationship that wish for its product to be considered and potentially installed by the end user, while the owner of the Interceptor 40 or container software can be thought of as the “publisher” that is displaying the advertised software product to the end user.

The Interceptor 40 may be configured to monitor and detect when a trigger event occurs on the user's client device 30, such as when a file is executed (or attempted to be executed) or when an application is launched (or attempted to be launched), regardless of the operation system running on the client device 30. The file execution or other trigger event detected by the Interceptor 40 may be performed manually by the user, such as when the user runs an executable file, or may be independent of the user's action, such as when a file is run to automatically install software without user interaction or when a software or application on the user's device is automatically updated. For example and without limitation, the Interceptor 40 may be further configured to monitor and detect when a specific type of file is executed on the user's client device 30, such as a setup or installer file, an uninstaller file, an executable (.exe) file, or a disk image (.dmg) file. As a further example, when an .exe file is run on the user's client device 30 (either manually by the user or as part of an automatic process) in order to execute a setup application, the Interceptor 40 may detect the application programming interface (API) call made when the setup application (e.g. an .exe file) is opened. Alternatively, the Interceptor 40 may detect the file execution through other suitable means, as discussed in detail below. When the Interceptor 40 detects the file execution, the Interceptor may suspend execution of the .exe file and may initiate a process to determine if an advertising offer or other content should be displayed (e.g., whether there is an appropriate advertised software application that the user may be interested in installing). When the Interceptor 40 suspends execution of a file, the Interceptor may do so by in a variety of different ways and depending on the specific file type, including without limitation by stopping the execution of the file (i.e., preventing the file from being executed), by pausing the execution of the file, by delaying execution of the file, or by other suitable methods of interrupting the execution of the file. Any one of these actions may also be referred to herein as performing an “intercept.” In alternative embodiments, opening other files including but not limited to .zip files, .msi files, or .rar files may also trigger an intercept by the Interceptor in accordance with the methods described herein. For ease of reference, the software file or application that is suspended by the Interceptor 40 will be referred to as the “intercepted software.”

After the Interceptor 40 performs an intercept by suspending execution of the file, the Interceptor 40 may first determine whether the file type of the intercepted software (in this example, the .exe file) is on a whitelist, which may include a listing of various file types or formats, file names, software owners/publishers, or other software attributes that may trigger the Interceptor 40 to provide another advertised software installation offer or other content to the user. The whitelist may also include other file attributes that are checked by the Interceptor 40 before the advertised software installation offer is presented to the user. Alternatively or additionally, a blacklist may be maintained to include file types, file names, software owners/publishers, or other software attributes that may prevent the Interceptor 40 from presenting an advertised software offer or other content to the user. In other words, the whitelist and blacklist can act as separate gatekeepers—the intercepted software must be on the whitelist and also not on the blacklist before the Interceptor 40 will present an advertised software installation offer or other content to the user. The whitelist and blacklist may be retrieved periodically by the Interceptor 40 from the server 22 and may be updated periodically on the server 22. Alternatively, the whitelist and blacklist may be maintained solely on the client device 30, or solely on the server 22 in which case the Interceptor 40 may send a request to the user to check the attributes of the intercepted software against the whitelist and blacklist maintained on the server 22.

Once the Interceptor 40 determines that the intercepted software passes the white list, the Interceptor 40 may then send a request to the server 22 to determine whether there are any appropriate advertised software installations or other content to offer to the user. Alternatively, where the client device 30 and server 22 are directly associated or part of the same machine, the Interceptor 40 may make the determination of whether there are any appropriate advertised software installation or other content locally without communicating with a server 22 over a network 32. The advertised software offered may include but are not limited to updates to applications already installed on the computer of the user, other software applications distributed by the publisher of the original .exe opened by the user, applications that complement what is already installed on the computer of the user, or software application offers from third parties that partner with the publisher of the Interceptor 40, the publisher of the container software that includes the Interceptor 40, or publisher of the original .exe opened. Other types of content may be displayed to the user aside from software applications, such as other advertising content or information content that the user may be interested in. The Interceptor 40 may additionally collect user and software data, which may be used in the process used by the server 22 or Interceptor 40 on the client device 30 to determine whether an advertised software installation offer or other content should be presented to the user. This user and software data may include but is not limited to the name and type of intercepted software, the publisher of the intercepted software, age of the installation for the Interceptor 40 or container software, the location of the user, the zone identity of the user assigned when the user installs applications, internet protocol (IP) address, and/or the software applications installed on the computer of the user.

The server 22 that received the request from the Interceptor 40 may then send a response to the Interceptor 40 with a list of advertised software application installers or other content to present as offers to the user. The list may be in any suitable format, including without limitation in the form of Extensible Markup Language (XML), JavaScript Object Notation (JSON), or an encrypted format. The server 22 may also provide a time period for which the Interceptor 40 should delay until performing a subsequent intercept. This delay period may help provide a better user experience, so that the user is not presented with advertised software offers or other advertising content too frequently. Alternatively, the list of advertised software application installers or other content may be maintained by the Interceptor 40 locally on the user's client device 30, and retrieved by the Interceptor 40 when making the determination of whether there are any appropriate offers to show to the user.

The Interceptor 40 may then present the advertised software installation offer or offers to the user using the installer of the advertised software or a custom installation mechanism. When presented with an advertised software installation offer, the user may decide to install the advertised software application or cancel/skip the installation, or the software installation may occur automatically depending on user action on the installation offer. When the user decides to accept the offered software installation, the Interceptor 40 retrieves the advertised software installer, such as by executing the .exe file previously downloaded and already stored on the client device of the user, and then runs and installs the advertised software. Alternatively, where the Interceptor 40 is not configured to pre-download and store the install files for the advertised software offers on the user's computer, the Interceptor 40 may respond to the user's acceptance of the advertised software installation by downloading the advertised software install file and then running the installer. The original .exe file opened for the intercepted software may then be resumed when the user has completed installation of the offered software application, cancels/skips the installation, or was not provided an advertised software installation offer. Where the content displayed to the user is not a software installation offer, the content may be displayed with or without suspending execution of the original .exe file, and may be displayed utilizing any suitable means, including without limitation through the Interceptor 40, the container software, or a software or application already on the user device, such as a web browser or system alert window. As discussed above, the Interceptor 40 may suspend execution of the original .exe file in a variety of ways, thus the specific manner in which the file execution is resumed may also vary (e.g., by re-launching the original .exe file, by un-pausing the .exe file, or by signaling that the delay in execution of the .exe file has been satisfied, etc.).

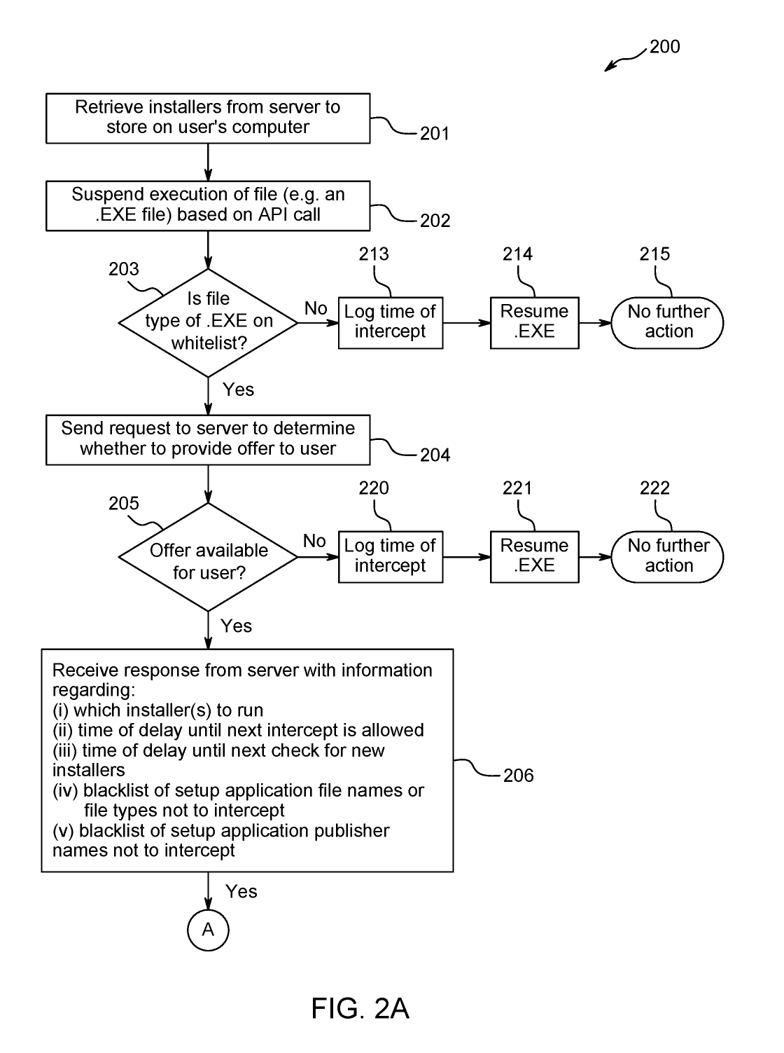

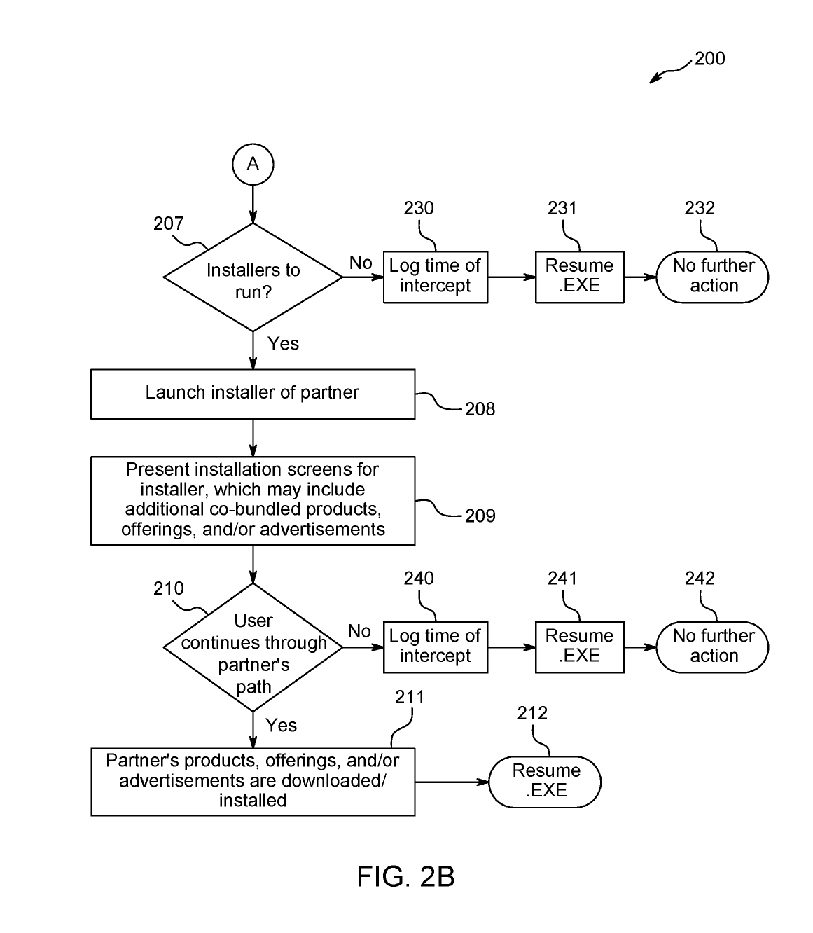

FIG. 2A-FIG. 2B is an example flow diagram of the intercept process 200 that may be performed by the Interceptor 40 in accordance with one example embodiment, which may be used in combination with any of the embodiments described herein, including the simplified sever 22 and client device 30 shown in FIG. 1. One of ordinary skill in the art would recognize that certain steps of the intercept process 200 may be optional, and that while each step of the process 200 in FIG. 2A-FIG. 2B is shown and described separately, multiple steps may be executed in a different order than what is shown, in parallel with each other, or concurrently with each other. Furthermore, the server 22 may be separate from and in communication with the client device 30, or may be directly associated with or a part of the client device 30, such that the requests sent to and the responses received from the server 22 are actually done locally on the client device 30 without sending information through a network. As discussed above, the Interceptor 40 may be configured to first retrieve materials for advertising offers or other content, such as installers for advertised software, from a server 22 and may store those installers or other content on the computer or other client device 30 of the user 201. Alternatively, the advertised software installers or other content may be retrieved from third-party servers, such as the servers of the owners or distributors of the advertised software or content, or may be downloaded from the internet. This retrieval and storage of advertised software installers or content may be performed upon initial installation of the Interceptor 40, such as when the Interceptor 40 is installed as a component of a container software. The Interceptor 40 may also check for new advertised software installers or content every time a predetermined time period expires. This predetermined time period may be received by the Interceptor 40 from the server 22 as explained below, or may be part of the programming of the Interceptor 40.

The Interceptor 40 may be configured to continuously or periodically monitor and detect when a file is executed or when another triggering event occurs on the user's client device 30. When the Interceptor 40 detects a triggering event such as the execution of a file, for example the execution of an .exe file of a setup application, based on an API 202 call when the .exe file is opened, the Interceptor 40 may suspend execution of the intercepted setup application. As discussed above, the file executed that is detected by and triggers the Interceptor 40 is not limited to an .exe file, but instead can be any file type including installer files, uninstaller files, .dmg files, .msi files, .zip files, .rar files, and any other file type for which interception is desired. Furthermore, in addition to responding to API calls, the Interceptor 40 may monitor and detect file execution based on other cues on the user's client device 30, such as through registry changes, overwritten files, new directories, or when certain files types are downloaded or saved. One of ordinary skill in the art would appreciate that there are various ways of detecting when files are executed on a user's computer, only some of which are listed here, and that as operating systems and computing devices develop and change, additional processes and indications may be used to detect file executions. Once the interception of the original setup application (the “intercepted software”) is made, the Interceptor may determine whether the file type of the intercepted software (in this example, the .exe file) is on a whitelist 203. If the file type of the intercepted software is not on the whitelist, then the time of the interception may be logged 213, the intercepted software may be resumed 214, and no further action may be taken 215. Provision of a whitelist is advantageous by preventing the Interceptor 40 from interfering with the user's computing experience by suspending too many file executions. Instead, the whitelist may be curated to include only file types for which interceptions and advertising offers such as recommended software installations make sense, such as installation and uninstallation file types. Furthermore, instead of or in addition to file types, the whitelist may include other file characteristics that can be used to determine whether the intercepted software should continue to be suspended.

If the file type of the intercepted software is on the whitelist, then the Interceptor 40 may send a request to a server 22 to determine whether to provide an advertising offer or offers to the user 204, such as an offer for an advertised software installation, or make the determination internally on the client device 30 level. The request message may be in any format and include any information consistent with the embodiments described herein. For example, the request may include but is not limited to the following information: user IP address, SubID parameter (to identify source), user agent, user location, current time, intercepted software file name and type, intercepted software publisher name, and age of the installation for the Interceptor 40 or container software. Other information that may be included may include the operating system and a list of software applications already installed on the user's client device 30.

A determination may then be made as to whether at least one advertising offer or other content is available for the user 205, which may be based on a number of considerations, including without limitation the information passed to the server (or evaluated internally by the Interceptor 40) in step 204, the time period between the current request and the last time an advertiser offer was presented to that user, and the user's past advertising offer display and acceptance history. For example, if information from the Interceptor 40 and/or server 22 show that the same user had previously been shown a number of advertising offers in the past 48 hours, it may be determined that no advertising offer should be shown at this time in order to avoid inundating the user with offers. As discussed above, this determination 205 may be made by the server 22, the Interceptor 40, or jointly. If no advertising offer or other content is available or determined to be suitable for the user, then the time of the intercept of the intercepted software may be logged 220, the intercepted software may be resumed 221, and no further action is taken 222. If at least one advertising offer, such as an advertised software installation, is available to the user, the Interceptor 40 may internally determine, or receive a response 206 from the server 22 with information including but not limited to one or more of the following:

(1) An identification of the installer associated with the at least one advertised software offer to run;

(2) A time period for delay until the next intercept is allowed;

(3) A time period for delay until the next check for new advertised software installers is performed;

(4) A blacklist of setup applications to not intercept; and

(5) A blacklist of setup application publisher names not to intercept (which may be part of the same blacklist of setup applications).

An example response 206 in XML from the server is the following:

```
<root>
  <installer>
    <name>InstallerName</name>
  </installer>
  <blacklist>
    <filenames>
      <name>ProgramSetup.exe</name>
      <name>ProgramSetup1.exe</name>
      <name>ProgramSetup2.exe</name>
      <name>ProgramSetup3.exe</name>
    </filenames>
    <publishers>
      <name>PublisherNameOne</name>
      <name>PublisherNameTwo</name>
      <name>PublisherNameThree</name>
      <name>PublisherNameFour</name>
    </publishers>
  </blacklist>
  <config>
    <time_intervals>
      <suggestions_delay>180</suggestions_delay>
      <fetch_installers>1800</fetch_installers>
    </time_intervals>
  </config>
</root>
```

Based on the information exchanged between the Interceptor 40 and the server 22, or considered internally by the Interceptor 40, a determination is then made by the Interceptor 40 or server 22 (or jointly) regarding whether there is at least one advertised software installer, offer, or other content to be presented to the user 207 based on the message received from the server 22. Once again, this determination may be based on a number of considerations or comparisons of data, including without limitation whether the intercepted software matches a file name, file type, or publisher identified in the blacklist, the time period between the current request and the last time an advertiser offer was presented to that user, and the user's past advertising offer display and acceptance history. Although this step may be optional, it is advantageous to prevent presenting the user with too many advertised software offers or other content, and to act as a secondary check for whether an advertised software offer should be shown for that specific intercepted software. For example, if the owner of Interceptor 40 or the container software has a partnership relationship with a particular software publisher to offer that publisher's advertised software through the Interceptor 40, the parties would want that publisher's name and its filenames to be on the blacklist, so that publisher's own software and files are not being intercepted. Additionally, if the owner of Interceptor 40 or the container software decides to no longer intercept a particular file type, that information can easily be added to the blacklist and periodically changed as required. If the Interceptor 40 or server 22 (or both components jointly) determines there is not at least one advertised software installer to be presented to the user, then the time of the intercept of the intercepted software may be logged 230, the intercepted software may be resumed 231, and no further action may be taken 232. If it is determined that there is at least one advertised software installer, offer, or other content to be presented to the user, the Interceptor may launch the at least one installer of the advertised software 208. Launching the at least one installer of the advertised software may include activating a display device to display the advertised installer, offer, or other content to the user. Screens may be presented 209 to the user during the installation path, which may also promote other products, offerings, and/or advertisements that are bundled along with the partner's advertised software. The partner that owns or distributes the advertised software may provide the screens to be presented to the user at step 209. Although shown at step 209 of the process 200, one of ordinary skill in the art would recognize that the screens offered by the partner or provided by the publisher of the container software may be part of the original advertised software installer downloaded and stored on the user's client device 30 by the Interceptor 40 during step 201 of the process 200, or may be downloaded and run in real time after it is determined at step 206 that the installer should be presented to the user, or may alternatively be incorporated in a custom installation and offer screen provided through the Interceptor 40 so that all advertised software installation offers have a consistent look and feel to the user.

The user may then continue through the partner's path 210 to install the at least one advertised software installer presented to the user. Alternatively, depending on the user's action with respect to the software installation offer, the advertised software may be installed automatically. If the user does not continue through the partner's installation path, such as when the user declines the offer, then the time of the intercept of the intercepted software may be logged 240, the intercepted software may be resumed 241, and no further action is taken 242. If the user continues through the partner's installation path or if the installation occurs automatically, then the partner's advertised software product, along with any additional offerings or advertisements are installed 211, and then the Interceptor 40 resumes the intercepted software originally run by the user 212. As discussed above, the owner of the Interceptor 40 or its container software may generate revenue by collecting a fee from the partner who owns the advertised software. If content other than a software installation offered is displayed, the partner who owns such content may nevertheless pay a fee to the owner of the Interceptor 40 or its container software for displaying that content to a user. While the fee may be based on merely presenting the advertised software offer or content to the user, more frequently the fee is based on a “pay per install” (PPI) basis, where the partner who owns the advertised software pays the owner of the Interceptor 40 or its container software for every successful installation of the advertised software. The fee may also be based on a “pay per action” (CPA) basis, where the partner who owns or distributes the advertisement or other content displayed to the user pays the owner of the Interceptor 40 or its container software for particular actions the user takes with respect to the displayed content, such as when the user clicks on the content or interacts with it in some way. Where the advertised software is co-bundled with additional software offers or other advertisements, the advertised software partner may also pay the owner of the Interceptor 40 or its container software a fee based on installation of the co-bundled products or a share of the revenues that the partner earns through the co-bundled products or advertisements.

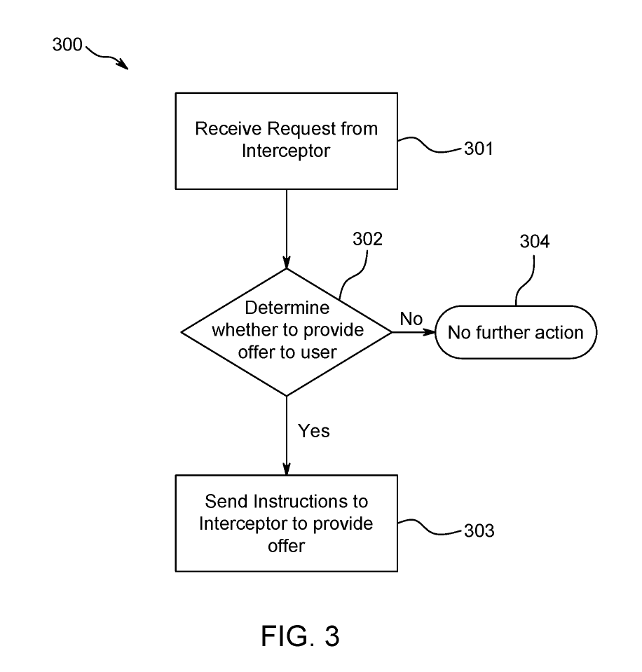

FIG. 3 is an example flow diagram of the server side process 300 that may be performed based on requests from the Interceptor 40 and may be used in combination with any of the embodiments described herein, including where the server 22 is directly associated with or part of the same machine or device as the client device 30. The server 22 may first receive a request from the Interceptor 301. The server 22 may then determine that an offer or other content, such as an advertised software installation offer, should be presented to the user 302. This decision to present an advertised software installation offer to the user may be based on various criteria and on the configuration of the system, as discussed in detail above. For example, the decision may be based on a hardcoded list. In the hardcoded list example, the server 22 may look up a hardcoded list of advertised software installers based on the countries that the advertiser (software installer) supports and/or based on how much the advertiser (i.e., the owner of the advertised software installer) pays on average for installs from those countries.

Alternatively, the decision to present an advertised software offer to the user 302 may be a recommendation provided by the server 22 and based on information including but not limited to the following:

(1) Location of the user;

(2) How many programs (including advertised software offers) the user has already installed;

(3) The advertised software installer's performance in the country of the user;

(4) The types of programs (including advertised software offers) the user already has installed;

(5) How often the user has had file executions suspended by the Interceptor 40; and/or

(6) The tracking source of the user.

If the server 22 makes a determination that no advertised software offers or other content should be presented to the user, no further action is taken 304. If the server 22 makes a determination that there is at least one advertised software offer or other content to present to the user, the server 22 sends a request to the Interceptor 49 to present the at least one advertised software offer 303 or other content.

Having thus described various embodiments of the Interceptor in detail, it is to be appreciated and will be apparent to those skilled in the art that many physical changes, only a few of which are exemplified in the detailed description above, may be made in the methods and apparatuses described herein without altering the inventive concepts and principles embodied herein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

Although features and elements are described above in particular combinations, it is to be appreciated that each feature or element can be used alone or in any combination with or without the other features and elements. Any single embodiment described herein may be supplemented with one or more elements from any one or more of the other embodiments described herein. Any single element of an embodiment may be replaced with one or more elements from any one or more of the other embodiments described herein. For example, each feature or element as described herein with reference to any one of FIGS. 1-3 may be used alone without the other features and elements or in various combinations with or without other features and elements from each or any combinations of the other figures from FIGS. 1-3. Each or any combination of features described herein with reference to FIGS. 1-3 may be considered optional. Sub-elements of the methods and features described herein with reference to FIGS. 1-3 may be performed in any arbitrary order (including concurrently) in any combination or sub-combination.

What is claimed is:

1. A method for presenting an offer to a user of a computing device, the method comprising:
detecting, by a processor, a file execution on the computing device;
suspending, by the processor, execution of an application on a condition that the file execution is associated with the application;
retrieving from memory, by the processor, data associated with at least one of the user or the suspended application;
sending, by a communication interface, a request to a server, wherein the request includes the data associated with at least one of the user or the suspended application;
receiving, by the communication interface, a response from the server, wherein the response includes a determination of whether the offer should be presented to the user based on the data associated with at least one of the user or the suspended application; and
on a condition that the determination of whether an offer should be presented to the user is positive, activating a display device to display the offer to the user based on the response from the server.

2. The method of claim 1, further comprising:
resuming, by the processor, the suspended application on the computing device.

3. The method of claim 1, further comprising:
on a condition that the determination of whether the offer should be presented to the user is negative, resuming, by the processor, the suspended application on the computing device.

4. The method of claim 1, wherein the offer is at least one of a software installation offer, an advertising offer, informational content, or a software installation offer that is provided by a different publisher from a publisher of the suspended application.

5. The method of claim 1, wherein the data associated with the user includes at least one of a location of the user, a zone identity of the user, a name of the suspended application, a file type of the suspended application, a publisher of the suspended application, an age of installation of the suspended application, or a list of software applications installed on the computing device.

6. The method of claim 4, wherein the response from the server is determined based on comparison of the suspended application data and data stored on a list stored on the server, the list including at least one of a whitelisted file type, a whitelisted file name, a blacklisted file type, a blacklisted file name, and a blacklisted publisher name.

7. The method of claim 1, wherein the computing device is at least one of a personal computer, a smartphone, a tablet computer, or a wearable smart device.

8. The method of claim 1, wherein the file execution detection is through detection of an application programming interface (API) call.

9. A non-transitory computer-readable storage medium with stored instructions executable by a computing device, the instructions comprising:
instructions to detect a file execution;
instructions to suspend execution of an application on a condition that the file execution is associated with the application;
instructions to retrieve from memory data associated with at least one of a user or the suspended application;
instructions to send a request to a server, wherein the request includes the data associated with at least one of the user or the suspended application;
instructions to receive a response from the server, wherein the response includes a determination of whether an offer should be presented to a user based on the data associated with at least one of the user or the suspended application;
instructions to activate a display device to display or not display the advertising offer based on the response from the server; and
instructions to resume the suspended application.

10. The computer-readable storage medium of claim 9, wherein the detection of the file execution comprises detecting an application programming (API) call.

11. The computer-readable storage medium of claim 9, wherein the offer is at least one of a software installation offer, an advertising offer, informational content, or a software installation offer that is provided by a different publisher from a publisher of the suspended application.

12. The computer-readable storage medium of claim 9, wherein the response from the server is determined based on at least one of the data associated with the user or the data associated with the suspended application data, wherein the data associated with the user includes a location of the user, a zone identity of the user, and an IP address of the user, and the suspended application data includes a file type of the suspended application, a file name of the suspended application, and a publisher name of the suspended application.

13. The computer-readable storage medium of claim 9, wherein the computing device is at least one of a personal computer, a smartphone, a tablet computer, or wearable smart device.

14. A method for sending an offer to a user of a computing device, the method comprising:
detecting, by a processor, a triggering event on the computing device;
suspending, by the processor, execution of an application on a condition at that the triggering event is associated with the application;
retrieving from memory, by the processor, at least one of data associated with the user or data associated with the triggering event;
sending, by a communication interface, a request to a server, wherein the request includes the at least one of data associated with the user or data associated with the triggering event;
receiving, by the communication interface, a response from the server, wherein the response indicates whether the offer is available to the user based on the at least one of data associated with the user or data associated with the triggering event; and
on a condition that the response from the server of whether the offer is available to the user is positive, activating a display device to display the offer to the user based on the response from the server.

15. The method of claim 14, further comprising:
resuming, by the processor, the suspended application on the computing device.

16. The method of claim 14, wherein the offer is at least one of a software installation offer, an advertising offer, or informational content.

17. The method of claim 16, further comprising the step of receiving, by an input device, a user input specifying whether the offer is accepted.

18. The method of claim 17, further comprising:
on a condition that the user input specifying whether the software installation offer is accepted is positive, retrieving a software installation file associated with the software installation offer and running the software installation file on the computing device; and
on a condition that the user input specifying whether the software installation offer is accepted is negative, sending, by the communication interface, information related to the user input to the server.

19. The method of claim 14, further comprising:
downloading, by the computing device, material associated with the offer; and
storing, by the memory, the material associated with the offer on the computing device.

20. The method of claim 14, wherein the triggering event comprises at least one of an application programming interface (API) call on the computing device, a registry change on the computing device, a file overwrite on the computing device, a file download on the computing device, or a file storage on the computing device.
